(19) United States
(12) Patent Application Publication
(10) Pub. No.: US 2012/0047002 A1
(43) Pub. Date: Feb. 23, 2012

(54) PROVIDING OFFERS BASED ON LOCATIONS WITHIN VIRTUAL ENVIRONMENTS AND/OR THE REAL WORLD

(75) Inventor: Pratik Patel, San Mateo, CA (US)

(73) Assignee: enVie Interactive LLC, Walnut Creek, CA (US)

(21) Appl. No.: 12/861,109

(22) Filed: Aug. 23, 2010

(51) Int. Cl. G06Q 30/00

(52) U.S. Cl. 705/14.1; 705/14.58

(57) ABSTRACT

Incentivized offers may be provided to users of a virtual environment. More specifically, a virtual environment may be provided to users such that the users participate in the virtual environment by performing one or more actions within the virtual environment. Information may be determined that relates to the physical locations in the real world of individual users of the virtual environment. Offers of goods and/or services may be determined that should be presented to individual users. The offers may be determined based on one or more of the physical locations in the real world of the individual users, virtual environment criteria representing one or more aspects of the users involvement in the virtual environment, and/or other factors. The determined offers may be transmitted to the users.

### FIELD OF THE INVENTION

The invention relates to providing incentivized offers based, at least in part, on locations of avatars in virtual environments and/or locations in the real world of users of virtual environments.

### BACKGROUND OF THE INVENTION

Typically, offers provided in the real world are redeemable in the real world. Similarly, offer provided in a virtual environment are generally redeemable in that virtual environment. In either case, offers extended to individuals may have limited relevance to those individuals' current situations.

### SUMMARY

One aspect of the invention relates to systems configured to provide offers to users of a virtual environment, as well as methods that may utilize those systems. An exemplary system may be configured to determine the offers based on the location and/or physical context of the user in the real world and/or virtual world criteria representing one or more aspects of the users' involvement in the virtual environment. This may extend the experiences of the users in the virtual environment into the real world and/or vice versa. As such, the immersion of the users in the virtual environment and/or the integration of the virtual environment into the real world may be enhanced. User immersion and/or real world integration may enhance user retention, user enjoyment, and/or other features of the virtual environment.

In some implementations, the system may include one or more servers, and/or other components. The servers may be in communication with one or more client computing platforms (e.g., personal computer, cellular phone, Smartphone, laptop computer, and/or other client computing platforms) used by users to interface with the servers. The servers may include electronic storage, one or more processors, and/or other components. The processors may be configured to execute an offer facilitation program. Execution of the offer facilitation program may enable the servers to, among other things, provide offers to users of a virtual environment. The offer facilitation program may include one or more computer program modules executable by the processors. The one or more computer program modules may include one or more of an environment module, a user module, a transaction module, a geo-location module, an offer determination module, an offer transmission module, an offer redemption module, and/or other modules.

The environment module may be configured to provide the virtual environment to users via individual client computing platforms in communication with the servers. As used herein, a “virtual environment” may include a virtual space, one or more interactive electronic media, and/or other virtual environments. A virtual space may comprise a simulated space (e.g., a physical space) that is accessible by a client computing platform in communication with the servers that presents a view of the virtual space to a user. Within a virtual space provided by the servers, avatars associated with the users may be controlled by the users to interact with the virtual space. Interactive electronic media may include one or more of a social network, a virtual space, a micro-blogging service, a blog service (or host), a browser-based game, a mobile game, a file (e.g., image file, video file, and/or other files) sharing service, a messaging service, a message board, a forum, and/or other electronically distributed media that are scalable and enable interaction between users and/or between users and the virtual environment.

The user module may be configured to manage user profiles corresponding to individual users. The user profiles may include user information related to the corresponding users. The user information may include one or more of identification/login information, demographic information, payment information, avatar information, inventory information, offer information, and/or other information.

The identification/login information may include information that identifies a user. This may include a username, a handle, a real world identification, an identification number, an email address, and/or other identification information.

The demographic information may include information indicating characteristics of the individual users. Such information may include, for example, sex, race, age, income, disabilities, mobility, educational attainment, home ownership, employment status, location, family status, and/or other demographic information.

The payment information may include information by which payment may be obtained from the users. The payment may be obtained for subscription fees, for purchases within the virtual environment, for purchases of real world goods and/or services through the virtual environment, and/or for other purchases.

The avatar information may include information pertaining to avatars associated with individual users. Such information may include, for example, a name, a race, a faction, a class, a guild, skill information identifying and quantifying skills held by avatars, relationship information (e.g., friendships), alliance information, achievement information, game progress/level information, and/or other avatar information.

The inventory information may include information defining inventories available to users within the virtual environment. Some or all of an inventory available to a user may be defined on a per-avatar basis, if the user has multiple avatars within the virtual environment. The inventory information may include, for example, virtual objects (e.g., weapons, tools, trinkets, badges, icons, bandages, potions, and/or other objects), virtual currency, clothing for avatars, vehicles, mounts, and/or other information related to other inventory within the virtual environment.

The offer information may include information related to the reception and/or redemption of offers by the users. For example, offer information may include information related to offers received, information indicating offers redeemed, information about offer redemption (e.g., timing, other items purchased, and/or other information), and/or other information related to offers.

The transaction module may be configured to manage transactions in which inventory in the virtual environment is received by a user, inventory is used, given, or lost by a user, inventory is traded between users, and/or other transactions involving inventory within the virtual environment. Such transactions may include transactions in which a user obtains inventory within the virtual environment. A user may obtain inventory within the virtual environment by performing actions and/or activities within the virtual environment (e.g., scavenging, crafting, grinding, defeating an opponent, and/or other activities), by purchasing inventory within the virtual environment (with real or virtual currency), through a gift of inventory within the virtual environment, by selling or trading inventory, and/or through other transactions. Inventory may be obtained in such transactions from the provider of the virtual environment, from another user within the virtual environment, from a third party provider of inventory (e.g., an entity conducting a promotion or advertisement within the virtual environment), and/or from other parties. In managing a transaction, transaction module may update the inventory information in user profile(s) managed by user module for the user(s) involved in the transaction.

The geo-location module may be configured to obtain the physical location in the real world of individual client computing platforms in communication with the servers. This may include receiving a transmission of information related to the physical location of a client computing platform, and determining the physical location of the client computing platform from this information. The information related to the physical location of the client computing platform may indicate the physical location of the client computing platform in real-time or near real-time. The transmission may include information generated by the client computing platform and/or a server, a transceiver, and/or other device (or devices) in communication with the client computing platform. The information related to the physical location of the client computing platform may include some form of geo-location information that specifies the physical location of the client computing platform.

The offer determination module may be configured to determine offers of goods, services, and/or other benefits that should be presented to individual users. The offers may include offers of real world goods and/or services at reduced prices and/or for free. The real world goods and/or services may be obtained by users at the reduced prices and/or for free from providers of the real world goods and/or services in the real world. The offers may include offers for inventory in the virtual environment (e.g., virtual goods, mounts, vehicles, weapons, and/or other inventory) at reduced prices and/or for free.

The offer determination module may be configured such that offers may require payment from a user, and/or offers may be free to the user. For example, upon being presented with an offer to purchase a real world good at a reduced price, the user may be required to pay for the offer. The price of the offer may be less than the reduction in price for the real world good. The price (or lack thereof) may be determined by offer determination module based on information received from providers of the offered real world goods and/or services, providers of the virtual environment inventory, and/or from other information.

The offer determination module may be configured to determine offers for users while they are currently accessing the virtual environment via individual client computing platforms in communication with the servers. The offer determination module may be configured to determine offers for users even while they are not currently accessing the virtual environment via an individual client computing platform in communication with the servers.

The offer determination module may be configured to determine offers for the users based on virtual environment criteria and/or real world physical location. The virtual environment criteria may include one or more of an activity performed or participated in within the virtual environment, inventory acquired in the virtual environment, a relationship with another user within the virtual environment, a class of an avatar, an affiliation of an avatar, a skill of an avatar, a location of an avatar within the virtual environment, and/or other criteria.

An activity performed or participated in within the virtual environment may include any act associated with users and/or avatars in the virtual environment. Activities performed or participated in within the virtual environment may include, for example, one or more of a transaction (e.g., a trade, a purchase, a sale, and/or other transaction), a deed, an endeavor, an enterprise, entertainment, a game, a hobby, a job, an avocation, an occupation, a project, a task, a trip, an undertaking, a venture, and/or other activities within the virtual environment.

Inventory acquired in the virtual environment may include virtual objects and/or real objects associated with a given user and/or avatar. In some implementations, virtual objects may include a branded virtual object or object associated with real world good, service, and/or merchant. Such virtual objects may result in corresponding real world offers. A virtual object may be obtained in any manner, including by purchase, gift, award, reward, and/or other manners.

A relationship with another user within the virtual environment may relate to a direct and/or indirect association with another user within the virtual environment, and/or other relationship. A direct association may relate to friend, teammate, colleague, partner, and/or other direct association. An indirect association may relate to a friend-of-a-friend, a member of a rival team and/or other organization, and/or other indirect association.

A class of an avatar within the virtual environment may relate a classification of the avatar. A class of avatar may include, for example, to a kind, a sort, a category, a breed, a cast, a degree, a denomination, a status, a designation, a distinction, a sect, a species, a family, a hierarchy, a league, a genre, a grade, an order, an origin, a quality, a social rank and/or other rank, a standing, and/or other class of avatar.

An affiliation of an avatar within the virtual environment may relate to an association with an organization within the virtual environment. An affiliation of an avatar may include, for example, membership in and/or association with a group, a faction, a guild, and/or other affiliations.

A skill of an avatar within the virtual environment may include an ability attributed to the avatar. Skills of an avatar may relate to a specific or general aptitude, competence, proficiency, ingenuity, experience, expertise, prowess, command, quickness, intelligence, readiness, skillfulness, and/or other skills.

A location of an avatar within the virtual environment may include a past and/or present proximity to a static location within the virtual environment. A static location within the virtual environment may include a virtual structure (e.g., a building, a store, a monument, and/or other structure), a virtual region (e.g., a park, a neighborhood, a city, and/or other region), and/or other static location.

The offer determination module may be configured to determine offers of goods and/or services that should be presented to individual users. In some implementations, an offer may be determined based on physical locations in the real world of individual users. Physical locations in the real world of individual users may be determined through execution of the geo-location module, by an indication of one or more individual users, and/or other techniques for determining physical location. According to some implementations, an offer may be determined based on virtual environment criteria representing one or more aspects of the users involvement in the virtual environment. The offer determination module may be configured to determine offers for users that are redeemable with providers of real world goods and/or services providers in the immediate proximities of the users.

The determination of offers by the offer determination module may take into account real world time, as well as location. For example, the determination may be based on events surrounding or nearby to the user. Such events may include periodic events at a given location (e.g., daily, weekly, monthly, yearly, and/or other periods), planned non-periodic events (e.g., a fair, a concert, a game, and/or other events), unplanned events (e.g., spontaneous events, breaking news, and/or other unplanned events), and/or other events. Information related to the real world location and/or timing of events may be obtained by offer transmission module from external resources (e.g., news sources, event planners, sponsors, and/or other external resources), from users in the virtual environment, and/or from other information sources.

The offer determination module may be configured such that offer providers can input offer criteria. Examples of offer criteria may include one or more of price, preferred virtual environment criteria, real world physical locations, real world times, number of offers, good or service, discount or freeness, and/or other offer criteria. Offer providers may input offer criteria through one or more client computing platforms in communication with the servers.

The offer transmission module may be configured to transmit one or more determined offers to one or more users. The offer transmission module may be configured to transmit the determined offers to the users through one or more communication media separate from the virtual environment. Communication media separate from the virtual environment may include, for example, a text message, an instant message, an email, a telephone call, a voice message, audio media, video media, printed media, and/or other communication media separate from the virtual environment. The offer transmission module may be configured to transmit the determined offers to the users within the virtual environment. Offers transmitted within the virtual environment may include, for example, a offer delivered by an avatar, a sign posted in the virtual environment, an offer delivered by a virtual radio DJ within the virtual environment, a virtual object obtained by an avatar associated with a user, and/or other offers transmitted in the virtual environment.

According to some implementations, the offer transmission module may be configured to retract one or more offers previously transmitted. A transmitted offer may be retracted if the offer is no longer relevant, has expired, and/or other reasons for retracting a transmitted offer. An offer may cease to be relevant when, for example, a user leaves a specified area in the real world, a user leaves a specified area in the real world for longer than a designated time, an avatar leaves a specified location within the virtual environment, an avatar leaves a specified location within the virtual environment for longer than a designated time, and/or other reasons an offer might cease to be relevant.

The offer redemption module may be configured to enable, track, and/or facilitate redemption of one or more offers by one or more users. Offers may be redeem by a user by, for example, providing a code (e.g., text, optical scan, and/or other codes) to a merchant, payment such as with a registered form of payment, an automatic redemption, and/or other redemption methods. Offers may be redeemed in the real world. Offers may be redeemed in the virtual environment. Offers may be redeemed online.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide offers to users of a virtual environment, according to one or more implementations of the invention.

FIG. 2 illustrates a method for providing offers to users of a virtual environment, according to one or more implementations of the invention.

### DETAILED DESCRIPTION

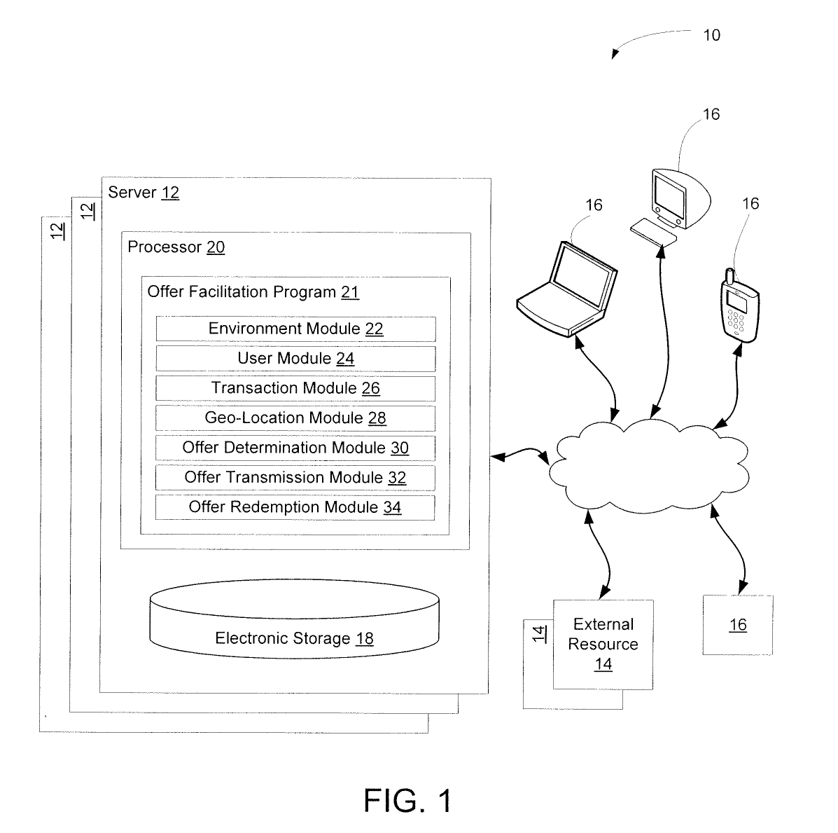

FIG. 1 illustrates a system 10 configured to provide offers to users of a virtual environment. The system 10 may be configured to determine the offers based on the location and/or physical context of the user in the real world and/or virtual world criteria representing one or more aspects of the users' involvement in the virtual environment. This may extend the experiences of the users in the virtual environment into the real world and/or vice versa. As such, the immersion of the users in the virtual environment and/or the integration of the virtual environment into the real world may be enhanced. User immersion and/or real world integration may enhance user retention, user enjoyment, and/or other features of the virtual environment.

In some implementations, system 10 may include one or more servers 12, and/or other components. The system 10 may operate in communication and/or coordination with one or more external resources 14. Users may interface with system 10 and/or external resources 14 via client computing platforms 16. The components of system 10, servers 12, external resources 14, and/or client computing platforms 16 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 12, external resources 14, and/or client computing platforms 16 may be operatively linked via some other communication media.

A given client computing platform 16 may include one or more processors configured to execute computer program modules. The computer program modules may be configured to enable one or more users associated with the given client computing platform 16 to interface with system 10 and/or external resources 14, and/or provide other functionality attributed herein to client computing platforms 16. By way of non-limiting example, the given client computing platform 16 may include one or more of a desktop computer, a laptop computer, a handheld computer, a NetBook, a Smartphone, a gaming console, and/or other computing platforms.

The external resources 14 may include sources of information, hosts and/or providers of virtual environments outside of system 10, external entities participating with system 10, and/or other resources. In some implementations, some or all of the functionality attributed herein to external resources 14 may be provided by resources included in system 10.

The servers 12 may be configured to provide the virtual environment to the users via client computing platforms 16. This may include serving the virtual environment to the users. The servers 12 may include electronic storage 18, one or more processors 20, and/or other components. The servers 12 may include communication lines, or ports to enable the exchange of information with a network and/or other computing platforms.

Electronic storage 18 may comprise electronic storage media that electronically stores information. The electronic storage media of electronic storage 18 may include one or both of system storage that is provided integrally (i.e., substantially non-removable) with servers 12 and/or removable storage that is removably connectable to servers 12 via, for example, a port (e.g., a USB port, a firewire port, etc.) or a drive (e.g., a disk drive, etc.). Electronic storage 18 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 18 may store software algorithms, information determined by processor 20, information received from servers 12, information received from client computing platforms 16, and/or other information that enables servers 12 to function properly.

Processor(s) 20 is configured to provide information processing capabilities in system servers 14. As such, processor 20 may include one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some implementations, processor 20 may include a plurality of processing units. These processing units may be physically located within the same device, or processor 20 may represent processing functionality of a plurality of devices operating in coordination.

As is shown in FIG. 1, processor 20 may be configured to execute an offer facilitation program 21. Execution of the offer facilitation program may enable the servers 12 to, among other things, provide offers to users of a virtual environment. The offer facilitation program 21 may include one or more computer program modules executable by the processor 20. The one or more computer program modules may include one or more of an environment module 22, a user module 24, a transaction module 26, a geo-location module 28, an offer determination module 30, an offer transmission module 32, an offer redemption module 34, and/or other modules. Processor 20 may be configured to execute modules 22, 24, 26, 28, 30, 32, and/or 34 by software; hardware; firmware; some combination of software, hardware, and/or firmware; and/or other mechanisms for configuring processing capabilities on processor 20.

It should be appreciated that although modules 22, 24, 26, 28, 30, 32, and 34 are illustrated in FIG. 1 as being co-located within a single processing unit, in implementations in which processor 20 includes multiple processing units, one or more of modules 22, 24, 26, 28, 30, 32, and/or 34 may be located remotely from the other modules. The description of the functionality provided by the different modules 22, 24, 26, 28, 30, 32, and/or 34 described below is for illustrative purposes, and is not intended to be limiting, as any of modules 22, 24, 26, 28, 30, 32, and/or 34 may provide more or less functionality than is described. For example, one or more of modules 22, 24, 26, 28, 30, 32, and/or 34 may be eliminated, and some or all of its functionality may be provided by other ones of modules 22, 24, 26, 28, 30, 32, and/or 34. As another example, processor 20 may be configured to execute one or more additional modules that may perform some or all of the functionality attributed below to one of modules 22, 24, 26, 28, 30, 32, and/or 34.

The environment module 22 may be configured to provide the virtual environment to users via client computing platforms 16. As used herein, a “virtual environment” may include a virtual space, one or more interactive electronic media, and/or other virtual environments.

A virtual space may comprise a simulated space (e.g., a physical space) that is accessible by a client (e.g., client computing platforms 16) that presents a view of the virtual space to a user. The simulated space may have a topography, express ongoing real-time interaction by the user, and/or include one or more objects positioned within the topography that are capable of locomotion within the topography. In some instances, the topography may be a 2-dimensional topography. In other instances, the topography may be a 3-dimensional topography. The topography may include dimensions of the virtual space, and/or surface features of a surface or objects that are “native” to the virtual space. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein). A virtual space may include a virtual world, but this is not necessarily the case. For example, a virtual space may include a game space that does not include one or more of the aspects generally associated with a virtual world (e.g., gravity, a landscape, etc.).

Within a virtual space provided by servers 12, avatars associated with the users may be controlled by the users to interact with the virtual space. As used herein, the term “avatar” may refer to an object (or group of objects) present in the virtual space that represents an individual user. The avatar may be controlled by the user with which it is associated. The avatars may move through and interact with the virtual space (e.g., non-player characters in the virtual space, other objects in the virtual space). The avatar associated with a given user may be created and/or customized by the given user. The avatar may be associated with an “inventory” of virtual goods and/or currency that the user can use (e.g., by manipulation of the avatar and/or the items) within the virtual space.

Interactive electronic media may include one or more of a social network, a virtual space, a micro-blogging service, a blog service (or host), a browser-based game, a mobile game, a file (e.g., image file, video file, and/or other files) sharing service, a messaging service, a message board, a forum, and/or other electronically distributed media that are scalable and enable interaction between users and/or between users and the virtual environment.

The user module 24 may be configured to manage user profiles corresponding to individual users. The user profiles may include user information related to the corresponding users. The user information may include one or more of identification/login information, demographic information, payment information, avatar information, inventory information, offer information, and/or other information.

The identification/login information may include information that identifies a user. This may include a username, a handle, a real world identification, an identification number, an email address, and/or other identification information. Such information may be set by the users and/or set automatically by processor 20. The identification/login information may include information that the user uses to access system 10. Such information may include a login, a password, a token key, and/or other information.

The demographic information may include information indicating characteristics of the individual users. Such information may include, for example, sex, race, age, income, disabilities, mobility, educational attainment, home ownership, employment status, location, family status, and/or other demographic information. The demographic information may be obtained from the users. For example, incentives may be provided to the users to encourage the users to voluntarily provide the demographic information.

The payment information may include information by which payment may be obtained from the users. The payment may be obtained for subscription fees, for purchases within the virtual environment, for purchases of real world goods and/or services through the virtual environment, and/or for other purchases. The payment information may include, for example, one or more of an account number, an account name, an expiration date, an account holder name, an account holder address, an institution providing a payment account, a billing address, and/or other information.

The avatar information may include information pertaining to avatars associated with individual users. Such information may include, for example, a name, a race, a faction, a class, a guild, skill information identifying and quantifying skills held by avatars, relationship information (e.g., friendships), alliance information, achievement information, game progress/level information, and/or other avatar information.

The inventory information may include information defining inventories available to users within the virtual environment. Some or all of an inventory available to a user may be defined on a per-avatar basis, if the user has multiple avatars within the virtual environment. The inventory information may include, for example, virtual objects (e.g., weapons, tools, trinkets, badges, icons, bandages, potions, and/or other objects), virtual currency, clothing for avatars, vehicles, mounts, and/or other information related to other inventory within the virtual environment. If the virtual environment includes a virtual space, the inventory information may include information defining topography within the virtual space that is controlled or owned by the users.

The offer information may include information related to the reception and/or redemption of offers by the users. For example, offer information may include information related to offers received, information indicating offers redeemed, information about offer redemption (e.g., timing, other items purchased, and/or other information), and/or other information related to offers.

The transaction module 26 may be configured to manage transactions in which inventory in the virtual environment is received by a user, inventory is used, given, or lost by a user, inventory is traded between users, and/or other transactions involving inventory within the virtual environment. Such transactions may include transactions in which a user obtains inventory within the virtual environment. A user may obtain inventory within the virtual environment by performing actions and/or activities within the virtual environment (e.g., scavenging, crafting, grinding, defeating an opponent, and/or other activities), by purchasing inventory within the virtual environment (with real or virtual currency), through a gift of inventory within the virtual environment, by selling or trading inventory, and/or through other transactions. Inventory may be obtained in such transactions from the provider of the virtual environment, from another user within the virtual environment, from a third party provider of inventory (e.g., an entity conducting a promotion or advertisement within the virtual environment), and/or from other parties. In managing a transaction, transaction module 26 may update the inventory information in user profile(s) managed by user module 24 for the user(s) involved in the transaction.

The geo-location module 28 may be configured to obtain the physical location in the real world of client computing platforms 16. This may include receiving a transmission of information related to the physical location of one of client computing platforms 16, and determining the physical location of the client computing platform 16 from this information. The information related to the physical location of the client computing platform 16 may indicate the physical location of the client computing platform 16 in real-time or near real-time. The transmission may include information generated by client computing platform 16 and/or a server, a transceiver, and/or other device (or devices) in communication with client computing platform 16. The information related to the physical location of client computing platform 16 may include some form of geo-location information that specifies the physical location of client computing platform 16. For example, the information related to the physical location of client computing platform 16 may include one or more of Internet protocol address, MAC address, RFID information, Wi-Fi connection location, GPS coordinates, information entered to client computing platform 16 by a user (e.g., specifying the location of client computing platform 16), and/or other information.

It will be appreciated that in order to determine the real-time or near real-time real world physical location of users, geo-location module 28 may be configured to receive information related to physical location from client computing platforms 16 not currently being used to access the virtual environment. For example, even while a user is not currently accessing the virtual environment, a Smartphone or client computing platform 16 may be transmitting location information to geo-location module 28. In some implementations, location information may be received from a client computing platform 16 that has not been, or even cannot be, used to access the virtual environment. For example, the Smartphone previously discussed may be considered to be one of client computing platforms 16 by virtue of the transmission of location information to geo-location module 28, but may not have the processing power, form factor, requisite software, and/or other characteristics such that the user can access the virtual environment from the Smartphone. Instead, the user may access the virtual environment from another client computing platform 16 (e.g., a laptop or desktop computer).

The offer determination module 30 may be configured to determine offers of goods, services, and/or other benefits that should be presented to individual users. The offers may include offers of real world goods and/or services at reduced prices and/or for free. The real world goods and/or services may be obtained by users at the reduced prices and/or for free from providers of the real world goods and/or services in the real world. The offers may include offers for inventory in the virtual environment (e.g., virtual goods, mounts, vehicles, weapons, and/or other inventory) at reduced prices and/or for free.

The offer determination module 30 may be configured such that offers may require payment from a user, and/or offers may be free to the user. For example, upon being presented with an offer to purchase a real world good at a reduced price, the user may be required to pay for the offer. The price of the offer may be less than the reduction in price for the real world good. The price (or lack thereof) may be determined by offer determination module 30 based on information received from providers of the offered real world goods and/or services, providers of the virtual environment inventory, and/or from other information.

The offer determination module 30 may be configured to determine offers for users while they are currently accessing the virtual environment via one of client computing platforms 16. The offer determination module 30 may be configured to determine offers for users even while they are not currently accessing the virtual environment via one of client computing platforms 16.

The offer determination module 30 may be configured to determine offers for the users based on virtual environment criteria and/or real world physical location. The virtual environment criteria may include one or more of an activity performed or participated in within the virtual environment, inventory acquired in the virtual environment, a relationship with another user within the virtual environment, a class of an avatar, an affiliation of an avatar, a skill of an avatar, a location of an avatar within the virtual environment, and/or other criteria.

An activity performed or participated in within the virtual environment may include any act associated with users and/or avatars in the virtual environment. Activities performed or participated in within the virtual environment may include, for example, one or more of a transaction (e.g., a trade, a purchase, a sale, and/or other transaction), a deed, an endeavor, an enterprise, entertainment, a game, a hobby, a job, an avocation, an occupation, a project, a task, a trip, an undertaking, a venture, and/or other activities within the virtual environment.

Inventory acquired in the virtual environment may include virtual objects and/or real objects associated with a given user and/or avatar. In some implementations, virtual objects may include a branded virtual object or object associated with real world good, service, and/or merchant. Such virtual objects may result in corresponding real world offers. A virtual object may be obtained in any manner, including purchase, gift, award, reward, and/or other manners.

A relationship with another user within the virtual environment may relate to a direct and/or indirect association with another user within the virtual environment, and/or other relationship. A direct association may relate to friend, teammate, colleague, partner, and/or other direct association. An indirect association may relate to a friend-of-a-friend, a member of a rival team and/or other organization, and/or other indirect association.

A class of an avatar within the virtual environment may relate a classification of the avatar. A class of avatar may include, for example, to a kind, a sort, a category, a breed, a cast, a degree, a denomination, a status, a designation, a distinction, a sect, a species, a family, a hierarchy, a league, a genre, a grade, an order, an origin, a quality, a social rank and/or other rank, a standing, and/or other class of avatar.

An affiliation of an avatar within the virtual environment may relate to an association with an organization within the virtual environment. An affiliation of an avatar may include, for example, membership in and/or association with a group, a faction, a guild, and/or other affiliations.

A skill of an avatar within the virtual environment may include an ability attributed to the avatar. Skills of an avatar may relate to a specific or general aptitude, competence, proficiency, ingenuity, experience, expertise, prowess, command, quickness, intelligence, readiness, skillfulness, and/or other skills.

A location of an avatar within the virtual environment may include a past and/or present proximity to a static location within the virtual environment. A static location within the virtual environment may include a virtual structure (e.g., a building, a store, a monument, and/or other structure), a virtual region (e.g., a park, a neighborhood, a city, and/or other region), and/or other static location.

The offer determination module 30 may be configured to determine offers of goods and/or services that should be presented to individual users. In some implementations, an offer may be determined based on physical locations in the real world of individual users. Physical locations in the real world of individual users may be determined through execution of the geo-location module 28, by an indication of one or more individual users, and/or other techniques for determining physical location. According to some implementations, an offer may be determined based on virtual environment criteria representing one or more aspects of the users involvement in the virtual environment. The offer determination module 30 may be configured to determine offers for users that are redeemable with providers of real world goods and/or services providers in the immediate proximities of the users.

The determination of offers by the offer determination module 30 may take into account real world time, as well as location. For example, the determination may be based on events surrounding or nearby to the user. Such events may include periodic events at a given location (e.g., daily, weekly, monthly, yearly, and/or other periods), planned non-periodic events (e.g., a fair, a concert, a game, and/or other events), unplanned events (e.g., spontaneous events, breaking news, and/or other unplanned events), and/or other events. Information related to the real world location and/or timing of events may be obtained by offer transmission module 32 from external resources 14 (e.g., news sources, event planners, sponsors, and/or other external resources), from users in the virtual environment, and/or from other information sources.

The offer determination module 30 may be configured such that offer providers can input offer criteria. Examples of offer criteria may include one or more of price, preferred virtual environment criteria, real world physical locations, real world times, number of offers, good or service, discount or freeness, and/or other offer criteria. Offer providers may input offer criteria through client computing platform 16.

The offer transmission module 32 may be configured to transmit one or more determined offers to one or more users. The offer transmission module 32 may be configured to transmit the determined offers to the users through one or more communication media separate from the virtual environment. Communication media separate from the virtual environment may include, for example, a text message, an instant message, an email, a telephone call, a voice message, audio media, video media, printed media, and/or other communication media separate from the virtual environment. The offer transmission module 32 may be configured to transmit the determined offers to the users within the virtual environment. Offers transmitted within the virtual environment may include, for example, an offer delivered by an avatar, a sign posted in the virtual environment, an offer delivered by a virtual radio DJ within the virtual environment, a virtual object obtained by an avatar associated with a user, a message offered within a messaging service or account in the virtual environment, an offer delivered through text or voice chat associated with the virtual environment, and/or other offers transmitted in the virtual environment.

According to some implementations, the offer transmission module 32 may be configured to retract one or more offers previously transmitted. A transmitted offer may be retracted if the offer is no longer relevant, has expired, and/or other reasons for retracting a transmitted offer. An offer may cease to be relevant when, for example, a user leaves a specified area in the real world, a user leaves a specified area in the real world for longer than a designated time, an avatar leaves a specified location within the virtual environment, an avatar leaves a specified location within the virtual environment for longer than a designated time, and/or other reasons an offer might cease to be relevant.

The offer redemption module 34 may be configured to enable, track, and/or facilitate redemption of one or more offers by one or more users. Offers may be redeem by a user by, for example, providing a code (e.g., text, optical scan, and/or other codes) to a merchant, payment such as with a registered form of payment (e.g., a registered credit or bank account), an automatic redemption, a coupon that can be printed out and provided to a merchant, an optical code that is displayable on a screen of one of client computing platforms 16 (e.g., a Smartphone) and presented to a merchant, and/or other redemption methods. Offers may be redeemed in the real world. By way of non-limiting example, a coupon offer transmitted in the real world and/or the virtual environment by the offer transmission module 32 may be redeemed at a real-world store associated with that coupon. Offers may be redeemed in the virtual environment. By way of non-limiting example, a text message offer transmitted in the real world and/or the virtual environment by the offer transmission module 32 may be redeemed at a restaurant within the virtual environment associated with that coupon. Offers may be redeemed online. By way of non-limiting example, an offer transmitted in the real world and/or the virtual environment by the offer transmission module 32 may be redeemed by an online retailer associated with that offer.

In order to track and/or facilitate redemption of offers, offer redemption module 34 may be configured to communicate with providers of goods and/or services associated with the offers, payment systems used to pay for the goods and/or services in the offers, and/or other entities involved in transactions in which users obtain the goods and/or services in the offers. The offer redemption module 34 may obtain information about redemption of offers via such communication. Information about the redemption of offers (e.g., for individual goods and/or services, for individual users, for individual merchants, and/or other information) may be stored, sold to third parties, used to determine offers that are presented in the future, and/or used for other purposes.

It is appreciated that, while only servers 12 are depicted in FIG. 1, some implementations may include one or more additional servers separate from the servers 12 that perform some or all of the functions attributed herein to the servers 12. For example, in accordance with some implementations, one additional server may host the virtual environment, while one or more other additional servers determine offers, transmit offers, manage offers, and/or perform other functions attributed herein to the servers 12.

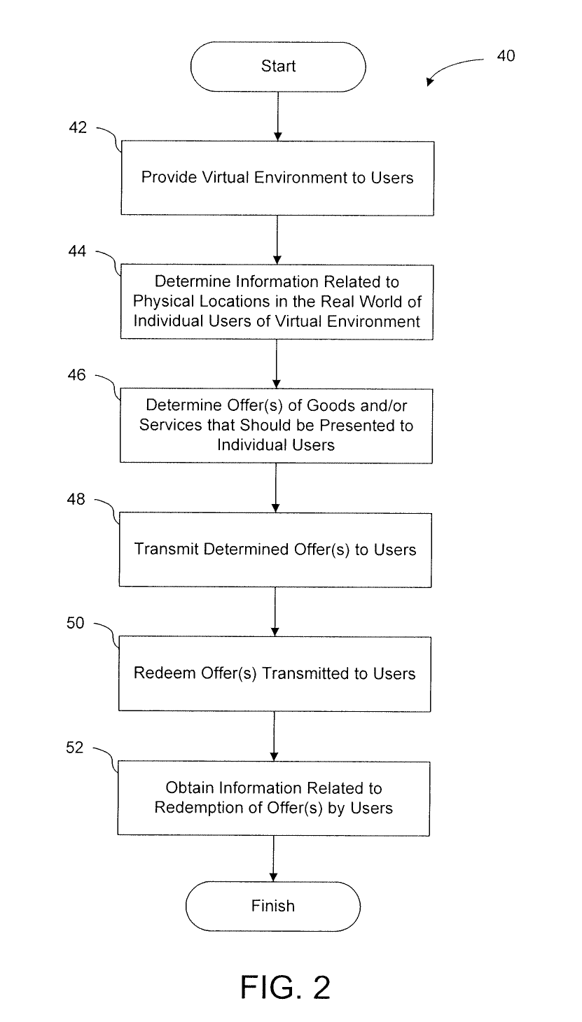

FIG. 2 illustrates a method 40 for providing offers to users of a virtual environment, according to one or more implementations of the invention. The operations of the method 40 presented below are intended to be illustrative. In some implementations, the method 40 may be accomplished with one or more additional operations not described, and/or without one or more of the operations discussed. Additionally, the order in which the operations of the method 40 are illustrated in FIG. 2 and described below is not intended to be limiting.

In some implementations, the method 40 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method 40 in response to instructions stored electronically on an electronic storage medium. The one or more processing devices may include one or more devices configured through hardware, firmware, and/or software to be specifically designed for execution of one or more of the operations of the method 40.

At an operation 42, a virtual environment may be provided to users. The users may participate in the virtual environment by performing one or more actions within the virtual environment. According to some implementations, the environment module 22 may be executed to perform the operation 42.

At an operation 44, information may be determined that relates to the physical locations in the real world of individual users of the virtual environment. The geo-location module 28 may be executed to perform the operation 44, in some implementations.

At an operation 46, offers of goods and/or services may be determined that should be presented to individual users. The offers may be determined based, at least in part, on the physical locations in the real world of the individual users. The offers may be based, at least in part, on virtual environment criteria representing one or more aspects of the users involvement in the virtual environment. In some implementations, the offer determination module 30 may be executed to perform the operation 46.

At an operation 48, the determined offers may be transmitted to the users. The operation 48, in accordance with some implementations, may be performed through execution of the offer transmission module 32.

At an operation 50, one or more offers transmitted to the users may be redeemed. This may involve one or more of the users obtaining the goods and/or services associated with offers through a transaction with corresponding providers of the goods and/or services. In some implementations, operation 50 may be performed by an offer redemption module similar to or the same as offer redemption module 34.

At an operation 52, information related to the redemption of offers by users may be obtained. Such information may include whether or not individual offers were redeemed, time of redemption, location of redemption, and/or other information. Such information may be stored, sold to third parties, used to determine offers that are presented in the future, and/or used for other purposes. In some implementations, operation 52 may be performed by a offer redemption module similar to or the same as offer redemption module 34.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

What is claimed is:

1. A system configured to provide incentivized offers to users of a virtual environment, the system comprising:
one or more processors configured to execute computer program modules, the computer program modules comprising:
an environment module configured to provide a virtual environment to users;
a geo-location module configured to determine information related to the physical locations in the real world of individual users of the virtual environment;
an offer determination module configured to determine offers of goods and/or services that should be presented to individual users based on (i) the physical locations in the real world of the individual users, and (ii) virtual environment criteria representing one or more aspects of the users involvement in the virtual environment; and
an offer transmission module configured to transmit the determined offers to the users.

2. The system of claim 1, wherein the virtual environment criteria comprise one or more of an activity performed or participated in within the virtual environment, inventory acquired in the virtual environment, a relationship with another user within the virtual environment, a class of an avatar, a skill of an avatar, or a location of an avatar within the virtual environment.

3. The system of claim 1, wherein the offers comprise incentives to purchase real world goods and/or services from real world goods and/or service providers.

4. The system of claim 3, wherein the incentives to purchase real world goods and/or services comprise incentives to make the purchases at real world provider locations, and wherein the incentives are redeemable at the real world provider locations.

5. The system of claim 1, wherein the geo-location module is configured such that the information related to the physical locations in the real world of the users indicates the locations of the users in real-time or near real-time.

6. The system of claim 5, wherein the offer determination module is configured to determine offers for the users redeemable with providers of real world goods and/or services providers in the immediate proximities of the users.

7. The system of claim 1, wherein the offer transmission module is configured to transmit the determined offers to the users through one or more communication media separate from the virtual environment.

8. The system of claim 1, wherein the offer transmission module is configured to transmit the determined offers to the users within the virtual environment.

9. A computer-implemented method of providing incentivized offers to users of a virtual environment, the method being implemented in a computer system comprising one or more processors configured to execute computer program modules, the method comprising:
providing a virtual environment to users such that the users participate in the virtual environment by performing one or more actions within the virtual environment;
determining information related to the physical locations in the real world of individual users of the virtual environment;
determining offers of goods and/or services that should be presented to individual users based on (I) the physical locations in the real world of the individual users, and (ii) virtual environment criteria representing one or more aspects of the users involvement in the virtual environment; and
transmitting the determined offers to the users.

10. The method of claim 9, wherein the virtual environment criteria comprise one or more of an activity performed or participated in within the virtual environment, inventory acquired in the virtual environment, a relationship with another user within the virtual environment, a class of an avatar, a skill of an avatar, or a location of an avatar within the virtual environment.

11. The method of claim 9, wherein the offers comprise incentives to purchase real world goods and/or services from real world goods and/or service providers.

12. The method of claim 11, wherein the incentives to purchase real world goods and/or services comprise incentives to make the purchases at real world provider locations, and wherein the incentives are redeemable at the real world provider locations.

13. The method of claim 9, wherein the information related to the physical locations in the real world of the users indicates the real world locations of the users in real-time or near real-time.

14. The method of claim 13, wherein the offers determined for the users are redeemable with providers of real world goods and/or services providers in the immediate proximities of the users.

15. The method of claim 9, wherein the determined offers are transmitted to the users through one or more communication media separate from the virtual environment.

16. The method of claim 9, wherein the determined offers are transmitted to the users within the virtual environment.

17. A non-transitory, computer-readable, electronic storage medium storing instructions configured to cause one or more processors to perform a method of providing incentivized offers to users of a virtual environment, the method comprising:
providing a virtual environment to users such that the users participate in the virtual environment by performing one or more actions within the virtual environment;
determining information related to the physical locations in the real world of individual users of the virtual environment;
determining offers of goods and/or services that should be presented to individual users based on (I) the physical locations in the real world of the individual users, and (ii) virtual environment criteria representing one or more aspects of the users involvement in the virtual environment; and
transmitting the determined offers to the users.

18. The electronic storage medium of claim 17, wherein the virtual environment criteria comprise one or more of an activity performed or participated in within the virtual environment, inventory acquired in the virtual environment, a relationship with another user within the virtual environment, a class of an avatar, a skill of an avatar, or a location of an avatar within the virtual environment.

19. The electronic storage medium of claim 17, wherein the offers comprise incentives to purchase real world goods and/or services from real world goods and/or service providers.

20. The electronic storage medium of claim 19, wherein the incentives to purchase real world goods and/or services comprise incentives to make the purchases at real world provider locations, and wherein the incentives are redeemable at the real world provider locations.

21. The electronic storage medium of claim 17, wherein the information related to the physical locations in the real world of the users indicates the real world locations of the users in real-time or near real-time.

22. The electronic storage medium of claim 21, wherein the offers determined for the users are redeemable with providers of real world goods and/or services providers in the immediate proximities of the users.

23. The electronic storage medium of claim 17, wherein the determined offers are transmitted to the users through one or more communication media separate from the virtual environment.

24. The electronic storage medium of claim 17, wherein the determined offers are transmitted to the users within the virtual environment.
